(19) United States
(12) Patent Application Publication
(10) Pub. No.: US 2009/0012735 A1
(43) Pub. Date: Jan. 8, 2009

(54) DEVICE FOR DETERMINING A ROTATIONAL SPEED ABOUT THE VERTICAL AXIS OF A VEHICLE

(75) Inventor: Thomas Reichmann, Kirchheim (DE)

Correspondence Address: FITCH, EVEN, TABIN & FLANNERY, P. O. BOX 18415, WASHINGTON, DC, 20036, US

(73) Assignee: DaimlerChrysler AG, Stuttgart (DE)

(21) Appl. No.: 10/575,891

(22) PCT Filed: Oct. 6, 2004
(86) PCT No.: PCT/EP04/11156

§ 371 Date: Aug. 24, 2006

(30) Foreign Application Priority Data
Oct. 17, 2003 (DE) 103 48 165.6

(51) Int. Cl. G01P 3/00; G01P 21/00

(52) U.S. Cl. 702/96; 702/145

(57) ABSTRACT

The invention relates to a device for determining a rotational speed about the vertical axis of a vehicle, comprising a rotational speed sensor which outputs a signal which is dependent on the rotational speed about the vertical axis, and a signal evaluation means which determines the rotational speed from the signal supplied by the rotational speed sensor.

According to the invention, a radiation sensor is provided for sensing an angle of a preceding vehicle located in the region ahead of the vehicle relative to the vehicle, the data from the radiation sensor being supplied to the signal evaluation means in order to sense the angle and being taken into account in the compensation of the offset error of the rotational speed sensor.

The invention relates to a device for determining a rotational speed about the vertical axis of a vehicle according to the preamble of patent claim 1.

The rotational movement of a motor vehicle about its vertical axis, that is to say the angular speed with which the motor vehicle rotates to the left or right (yaw rate) can be determined by means of a rotational speed sensor. The curvature of the current section of road can be calculated using the actual speed of the motor vehicle. In systems which permit inter-vehicle distance warning or control with respect to vehicles ahead or obstacles it is necessary to have a precise prediction of a vehicle's own lane. This prediction is a feature which makes it possible to distinguish whether the vehicles traveling ahead are on the vehicle's own lane or next. In addition to curvatures which are determined from variables such as steering angle and wheel speed, a curvature which is determined from the rotational speed is often used for the prediction.

Rotational speed sensors are generally subject to what is referred to as an offset error. This more or less pronounced error causes, inter alia, the rotational speed sensor to predefine a rotational movement about the vertical axis of the motor vehicle even though the motor vehicle is not rotating at all. However, for precise prediction of the course of a vehicle only slight offset errors can be tolerated. A drift in the offset error, in particular as a result of thermal influences, is also a large problem.

It is possible, for example, for the offset error to be compensated when the motor vehicle is stationary. When the vehicle is not moving, the sensor output signal, freed of noise due to the system by average value formation, directly to the offset error. In any stationary state of a vehicle, a thermal error can thus also be compensated by a new adjustment. However, in stationary state adjustment it proves problematic to detect the complete stationary state of the vehicle by means of the time interval which is necessary for average value formation. A stationary state of a motor vehicle can only be detected inadequately by means of wheel speed sensors owing to their resolution since creepage of the motor vehicle, for example when parking or when stopping at traffic lights can only be detected inadequately, but as a result severe falsification of the offset error is possible. Additionally including brake pressure information in order to determine the force with which the driver effects the brake can lead a situation in which adjustment is not carried out in all necessary cases. For example, if a stationary state of a vehicle is detected by means of the wheel speed sensors even though the driver is depressing the brake only slightly, or even not at all.

Furthermore, with this type of compensation a stationary state of a vehicle is always necessary in order to compensate thermal offset drift, which it is not possible to assume in practice. In particular with networked control devices, the time may also be too short for average value formation and it is thus not possible to determine a compensation value when starting a vehicle, owing to the system start times. This is also the case when the ignition is switched off and on again while traveling.

A further compensation possibility is to use further variables from other sensors, for example, steering angle, rotational speed differences or a lateral acceleration, to detect straight-ahead travel of the vehicle. In this way it is also possible to perform compensation against the temperature without the need for a specific condition such as a stationary state of the vehicle. It is problematic that these further sensors are usually also subject to an offset error. With precise determination of the offsets of the further sensors, straight-ahead travel can in turn only be detected unsatisfactorily. Since these variables are usually also used for course prediction, mutual dependence of the offset errors and their effect on the prediction of a course. The prediction of the course can be determined only imprecisely, in particular if none of the offset errors of the further sensors is known, for example in the case of a new vehicle or control unit at the end of a production line. Furthermore, differences in the inclination of the carriageway effect for example the steering angle when straight-ahead travel is sensed even though the correct offset error is known.

DE 196 25 058 A1 discloses a device for determining a rotational speed, in particular in a motor vehicle, having a first sensor system which outputs a signal which is dependent on the rotational speed, and which operates according to a first measurement principle. The rotational speed is derived from the signal by means of signal evaluation means. In addition, a second sensor system is provided which outputs the signal which is dependent on the rotational speed and operates according to a second measurement principle. The signals of the second sensor system are also fed to the signal evaluation means and also taken into account in the determination of the rotational speed. The first sensor system is a compass and the second sensor system comprises an oscillating structure which supplies a signal which is dependent on the Coriolis force. Long time drifting, offset errors and sensitivity over the service life are reliably eliminated since recalibration can be carried out automatically.

The invention is then based on the object of specifying an alternative device for determining a rotational speed of a motor vehicle in which the offset error is compensated.

The object is achieved by means of a device for determining a rotational speed about the vertical axis of a vehicle having the features of patent claim 1.

According to the invention, the radiation sensor is used for sensing the angle of a preceding vehicle located in the region ahead of the vehicle relative to said vehicle. The data from the radiation sensor is supplied to the signal evaluation means in order to sense the angle and taken into account in the compensation of the offset error of the rotational speed sensor. The device for determining a rotational speed about the vertical axis of the vehicle comprises the rotational speed sensor which outputs a signal which is dependent on the rotational speed about the vertical axis, and the signal evaluation means which determines the rotational speed from the signal which is supplied by the rotational speed sensor. By using the radiation sensor for sensing the angle of the preceding vehicle located in the region ahead of the vehicle, in particular a radiation sensor which is embodied as an inter-vehicle distance sensor, it is possible to dispense with using a further rotational speed sensor or a measurement system for determining the rotational speed. Radiation sensors are generally aligned precisely with the longitudinal axis of the vehicle by means of external adjustment devices at the end of the production line or in the workshop. As a result, possible angle errors are already ruled out by the adjustment. A large number of vehicles are also equipped on a series-production basis with a system for detecting inter-vehicle distance so that the device according to the invention can be implemented cost-effectively and with only low expenditure.

In one advantageous refinement, only signals of the rotational speed sensor at which the angle of the preceding vehicle located in the region ahead of the vehicle is approximately 0 degrees are used to determine the offset error. Then, the vehicle and the vehicle ahead move approximately on a straight line. The compensation of the offset error can be carried out during travel, as a result of which, for example, drifting effects as a result of changes in temperature can be taken into account. In order to detect straight-ahead movement of the vehicle there is no need for a further signal which is subject to an offset and which detects the movement of the vehicle by means of the steering angle or the rotational speed, for example. An offset which is determined using these variables is generally subject to a large error. In order to determine straight-ahead travel by means of differences in rotational speed there may only be minimum differences in rotational speed between the wheels of the vehicle. The degree of precision needed for the wheel speed sensors installed in vehicles and also that which is needed for steering angle sensors is much less than what is necessary to compensate the offset error of the rotational speed sensor.

It is advantageous if only the signals of the rotational speed sensor which are sensed in a predefined time interval are used to determine the offset error and are averaged over the signals of the rotational speed sensor which are sensed in the predefined time interval. By averaging over the time interval, during which process the time interval should have a predefined minimum length for sensing a sufficiently large number of signals of the rotational speed sensor, the current offset error of the rotational speed sensor can be determined precisely. The offset error can also be determined by summing the signals of a plurality of suitable approach journeys. In this context it is necessary to take into account the fact that the approach journeys are not too far apart chronologically so that changes due to temperature can be sensed.

Further advantageous refinements of the invention are reproduced in the subclaims.

The invention is explained in more detail in the single FIGURE by reference to an exemplary embodiment, the FIGURE showing a typical driving situation for a motor vehicle on a road in a schematic illustration.

The vehicle 1 which is illustrated in the FIGURE is traveling on a carriageway 2 of a road 3, the carriageway 2 being separated from an oncoming carriageway 4 of the road 3 by a central divider 5. The respective direction of travel is indicated by the arrows 6 and 7.

A device 8 for determining a rotational speed about the vertical axis of the vehicle 1 comprises a rotational speed sensor 9 which outputs a signal which is dependent on the rotational speed about the vertical axis, and a signal evaluation means 10 which determines the rotational speed from the signal which is supplied to the rotational speed sensor 9. Furthermore, a radiation sensor 11 is provided for sensing an angle 12 of a preceding vehicle 13, 14 located in the region ahead of the vehicle 1, in relation to said vehicle 1. The angle 12 can be determined in relation to the longitudinal axis 15 of the vehicle 1. However, it can also be sensed in relation to another axis of the vehicle 1. The data of the radiation sensor 11 for sensing the angle 12 is supplied to the signal evaluation means 10 and taken into account in the compensation of the offset error of the rotational speed sensor 9. The radiation sensor 11 may be, for example, a sensor which senses in the radar range. Depending on the embodiment, the radiation sensor 11 can be used to sense the preceding vehicle 13, 14 in a distance range from approximately 20 to 200 meters from the vehicle 1.

Only the signals of the rotational speed sensor 9 at which the angle 12 of the preceding vehicle 13, 14 located in the region ahead of the vehicle 1 is approximately 0 degrees are used to determine the offset error. In this case, the arrangement of the vehicle 1 and of the preceding vehicle 13 on the carriageway 2 of the road 3 is particularly favorable since the vehicle 1 and the preceding vehicle 3 move approximately on a straight line. The vehicle 1 and the preceding vehicle 13 move in the same direction of travel, indicated by the arrow 6, the actual speed of the preceding vehicle 13 being higher or lower than the actual speed of the vehicle 1. As the journey continues, the vehicle 1 moves away from the preceding vehicle 13 or moves toward it as a function of the relative speed. The preceding vehicle 14 which is coming towards the vehicle 1 on the opposite carriageway 4 of the road 3, indicated by the arrow 7, is detected at a larger angle 12 than the preceding vehicle 13. In order to differentiate the oncoming preceding vehicle 14 from the preceding vehicle 13, the latter moving in the same direction as the vehicle 1, it is possible to calculate the relative speed by means of the radiation sensor 11. The oncoming preceding vehicle 14 will generally have a significantly higher relative speed with respect to the vehicle 1 than the preceding vehicle 13 or than its own speed.

In order to determine the offset error, the signals of the rotational speed sensor 9 which are sensed in a predefined time interval can be used to determine the offset error. The predefined time interval comprises a time period in which the vehicle 1 moves approximately linearly toward the preceding vehicle 13, and the actual speed of the preceding vehicle 13 is in this case lower than that of the vehicle 1, or moves approximately linearly away from it, while in the latter case the actual speed of the preceding vehicle 13 is higher than the actual speed of the vehicle 1. Averaging over the rotational speeds of the rotational speed sensor 9 which are determined in the predefined time interval yields the current offset error of the rotational speed sensor 9. It is also possible to sum the time intervals during a plurality of approach journeys as long as they are not too far apart chronologically in order to be able to eliminate changes in the offset error due to temperature. The predefined time interval should have a predefined minimum length in order to be able to average over a sufficient number of rotational speeds for a sufficiently precise result of the offset error.

In addition, by forming gradients it is possible to determine a change in the rotational speed of the rotational speed sensor 9 over time in order to draw conclusions about the stability of the rotational speed. When the vehicle 1 is approaching the preceding vehicle 13 linearly on the carriageway 2 of the road 3, the change in the rotational speed over time is very low. Forming gradients allows existing curvatures to be averaged out.

The device 8 according to the invention for averaging the rotational speed about the vertical axis of the vehicle 1 is defined by its simple functionality, the offset error of the rotational speed sensor 9 being simultaneously determined with a high degree of precision. There is no need for a further rotational speed sensor 9. In addition, no further sensors are used to determine parameters which describe the driving state of the vehicle 1 and which may themselves be subject to an offset error. Cost-effective implementation of the device 8 in the vehicle 1 is ensured.

1. A device (8) for determining a rotational speed about the vertical axis of a vehicle (1), comprising a rotational speed sensor (9) which outputs a signal which is dependent on the rotational speed about the vertical axis, and a signal evaluation means (10) which determines the rotational speed from the signal supplied by the rotational speed sensor (9), characterized in that a radiation sensor (11) is provided for sensing an angle (12) of a preceding vehicle (13, 14) located in the region ahead of the vehicle (1) relative to the vehicle (1), the data from the radiation sensor (11) being supplied to the signal evaluation means (10) in order to sense the angle (12) and being taken into account in the compensation of the offset error of the rotational speed sensor (9).

2. The device (8) as claimed in claim 1, characterized in that only signals of the rotational speed sensor (9) at which the angle (12) of the preceding vehicle (13, 14) located in the region ahead of the vehicle (1) is approximately 0 degrees are used to determine the offset error.

3. The device (8) as claimed in claim 1, characterized in that only the signals of the rotational speed sensor (9) which are sensed in a predefined time interval are used to determine the offset error and are averaged over the signals of the rotational speed sensor (9) which are sensed in the predefined time interval.

4. The device (8) as claimed in claim 1, characterized in that the change in the rotational speed of the rotational speed sensor (9) can be determined over time in order to draw conclusions about the stability of the rotational speed.

5. The device (8) as claimed in claim 1, characterized in that the angle (12) of the preceding vehicle (13, 14) located in the region ahead of the vehicle (1) can be determined in relation to the longitudinal axis (15) of the vehicle (1).

6. The device (8) as claimed in claim 1, characterized in that the vehicle (1) and the preceding vehicle (13) move in the same direction of travel, the actual speed of the preceding vehicle (13) being greater than or less than the actual speed of the vehicle (1).
